(19) United States
(12) Patent Application Publication
(10) Pub. No.: US 2025/0091192 A1
(43) Pub. Date: Mar. 20, 2025

(54) POWER TOOL, A HANDLE FOR A POWER TOOL AND A METHOD OF ASSEMBLY

(71) Applicant: Black & Decker, Inc., New Britain, CT (US)

(72) Inventors: Arthur LAUER, Frankfurt (DE); Klaus-Dieter ARICH, Huenstetten-Beuerbach (DE); Ashwin RAJENDRAN, Idstein (DE); Heiko LANGHAMMER, Idstein (DE); Daniel KADLECEK, Bischofsheim (DE); Timo RAAB, Mainz (DE)

(21) Appl. No.: 18/888,632

(22) Filed: Sep. 18, 2024

(30) Foreign Application Priority Data
Sep. 18, 2023 (EP) 23197900

(51) Int. Cl. B25F 5/02

(52) U.S. Cl. CPC B25F 5/02

(57) ABSTRACT

A power tool including a housing, at least one handle mountable to the housing, a motor mounted in the housing and electrically connected to a power source, and at least one component with at least one electrical connection electrically connected to the power source. The handle includes an internal cavity, and the component is mountable within the cavity. The handle also features a handle slot configured to receive the electrical connection when the component is mounted within the handle. This design allows for easier assembly and attachment of power cables and electronic components within the handle of the power tool.

### CROSS-REFERENCE TO RELATED APPLICATIONS

The present application claims priority to European Patent Application No. EP23197900 filed on Sep. 18, 2023, which is herein incorporated by reference in its entirety.

### FIELD OF THE INVENTION

The present disclosure relates to a power tool. In particular, the present disclosure relates to routers.

### BACKGROUND OF THE INVENTION

A power tool such as a router may be utilized by tradesmen, craftsmen, hobbyists and other users to perform various tasks. For instance, a router may be used to perform intricate cutting projects, such as decorative profiles and trimming laminates on the edges or perimeters of a workpiece. A router also may be utilized to form grooved areas in woodworking and other material as well as to remove excess material on workpieces. Routers may utilize various types of cutting tools or router bits in order to perform these and other types of tasks.

In some routers, as shown in WO2021/219349, a trigger switch is provided for the user to control the operation of the router. The trigger switch is mounted in a handle mounted to the main housing of the router and must be connected to the motor and circuit unit. The assembly of the trigger switch in the handle is time consuming and difficult.

It may not be possible to attach electrical wires to the trigger switch after being inserted within the handle because there is limited room within the handle. Furthermore, if the electrical wires are attached before the trigger switch is mounted within the handle, then the overall assembly of the power tool is harder.

### SUMMARY OF THE INVENTION

Examples of the present disclosure aim to address the aforementioned problems.

According to an aspect of the present disclosure there is provided a power tool comprising a housing, at least one handle mountable to the housing, a motor mounted in the housing and electrically connected to a power source, and at least one component with at least one electrical connection electrically connected to the power source. The handle comprises an internal cavity, and the component is mountable within the internal cavity. The handle also comprises a handle slot configured to receive the electrical connection when the component is mounted within the handle. This aspect allows for easier assembly and attachment of power cables and electronic components within the handle.

Optionally in some examples, the handle slot is configured to receive the electrical connection when the handle is mounted to the housing. This provides a more secure and stable connection between the handle and the housing.

Optionally in some examples, a handle slot insert is configured to engage the handle slot and fill the slot.

Optionally in some examples, the handle slot insert comprises at least one projecting lip configured to engage an internal shoulder portion of the handle. This ensures a secure fit of the insert within the handle slot.

Optionally in some examples, the handle slot extends at least partially around the periphery of the handle.

Optionally in some examples, a portion of the handle slot extends in a direction parallel with the handle axis. This provides a more streamlined and efficient design for the power tool.

Optionally in some examples, the handle slot insert is configured to slide into engagement with the handle slot in a direction parallel with the handle axis. This allows for easy assembly and disassembly of the power tool.

Optionally in some examples, the handle comprises a handle body portion mountable to the housing and a cap portion mountable on the handle body portion. This provides a more secure and stable connection between the handle and the housing.

Optionally in some examples, the cap is configured to be mounted to the handle body portion and prevent the handle slot insert from sliding out of the handle slot.

Optionally in some examples, the handle slot extends along the entire side of the handle body portion. This provides a more versatile and adaptable design for various power tool configurations.

Optionally in some examples, the cap portion seals an end of the housing body portion when mounted to the housing body portion. This helps to protect the internal components of the power tool from dust and debris.

Optionally in some examples, the handle slot insert seals the handle slot when in engagement with the handle slot. This provides additional protection for the electrical connection.

Optionally in some examples, the electrical connection is a plurality of wires.

Optionally in some examples, the component is a trigger switch.

Optionally in some examples, the handle comprises a “T” shape. This provides a more ergonomic and comfortable grip for the user.

Optionally in some examples, the power tool is a router. This disclosure is particularly well-suited for use in routers, but may also be applied to other power tools.

Optionally in some examples, the electrical connection is connected via at least one folded electrical tab.

According to a second aspect of the disclosure, a handle mountable on a housing of a power tool having a motor mounted in the housing and electrically connected to a power source is provided. The handle comprises an internal cavity configured to receive at least one component with at least one electrical connection electrically connected to the power source and is mountable within the internal cavity. The handle also comprises a handle slot configured to receive the electrical connection when the component is mounted within the handle.

According to a third aspect of the disclosure, a method of assembling a power tool is provided. The method comprises mounting a motor in a housing, electrically connecting at least one component with the power source with at least one electrical connection, inserting the component in an internal cavity of at least one handle and mounting the handle to the housing, and passing the electrical connection through the handle slot after mounting the handle to the housing. This method allows for easier assembly and attachment of power cables and electronic components within the handle.

### BRIEF DESCRIPTION OF THE DRAWINGS

Various other aspects and further examples are also described in the following detailed description and in the attached claims with reference to the accompanying drawings, in which:

FIG. 1 shows a front view of a power tool according to an example;

FIG. 2 shows a side cross-sectional view of a power tool according to an example;

FIG. 3 shows plan view of a power tool according to an example;

FIG. 4 shows a side view of a power tool according to an example;

FIG. 5 shows another perspective view of a power tool according to an example;

FIG. 6 shows an exploded perspective view of a power tool according to an example;

FIG. 7 shows an exploded perspective view of the top portion of a power tool according to an example,

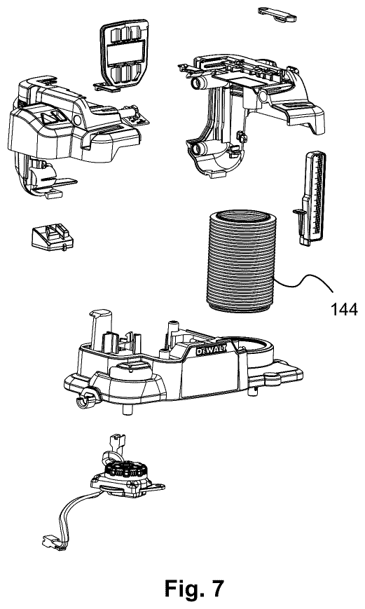

FIG. 8 shows an exploded perspective view of a handle of a power tool according to an example;

FIG. 9 shows a cross-sectional view of a handle of a power tool according to an example, and

FIG. 10 shows a close-up perspective view of a power tool according to an example.

### DETAILED DESCRIPTION OF THE INVENTION

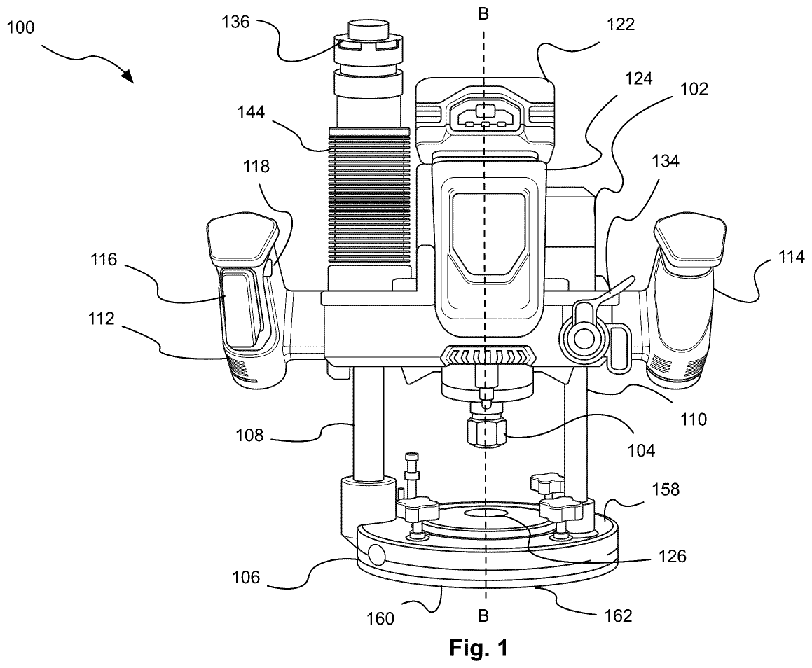

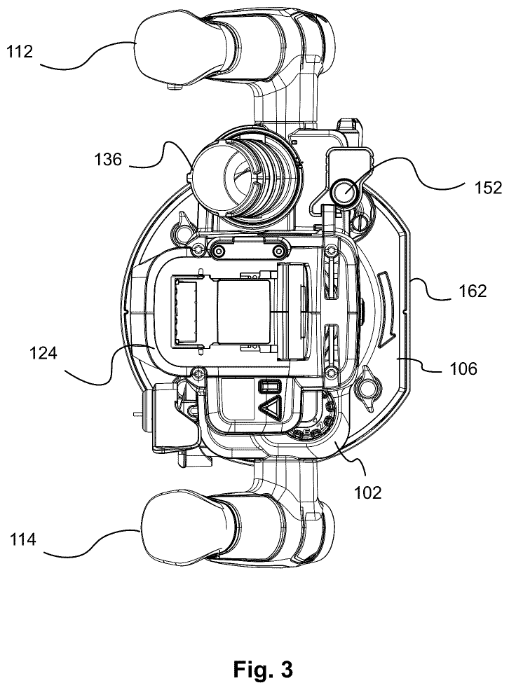

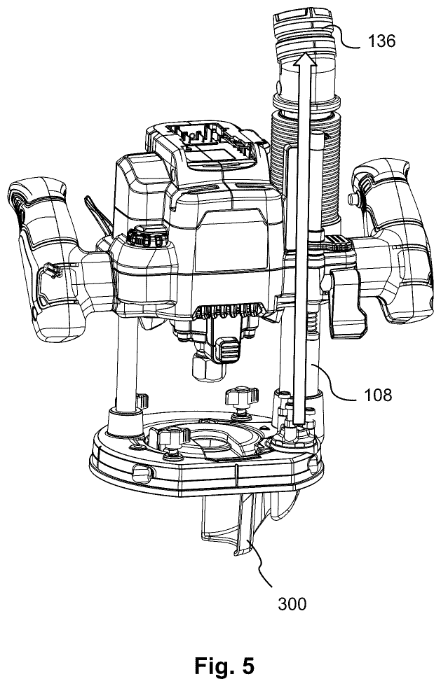

FIG. 1 shows a front view of a power tool 100 according to an example. FIGS. 3, 4 and 5 also respectively show a plan view, a side view and a perspective view of the same power tool 100. The power tool 100 as shown in FIG. 1 is a router 100. Whilst the power tool 100 can be a router 100, in other examples any other type of power tool can be used such as a plunge saw, a drill, a multitool, or an oscillating tool mounted on a plunge base portion 106. Hereinafter, the term power tool 100 will be used.

The power tool 100 comprises a housing 102. The housing 102 comprises a clam shell type construction having two halves which are fastened together. The halves of the housing 102 are fastened together with screws but in alternative examples any suitable means for fastening the housing 102 together may be used such as glue, clips, bolts and so on. For the purposes of clarity, the fastenings in the housing 102 are not shown.

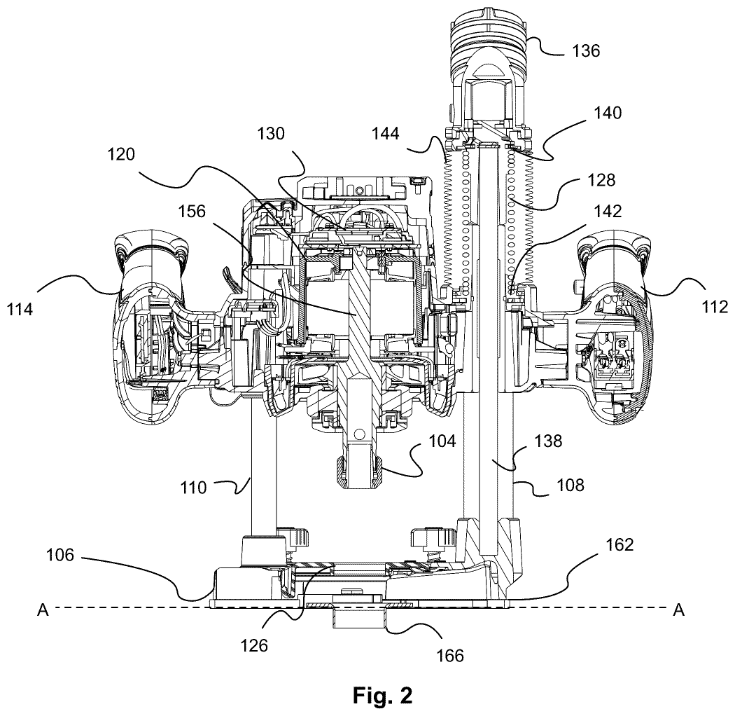

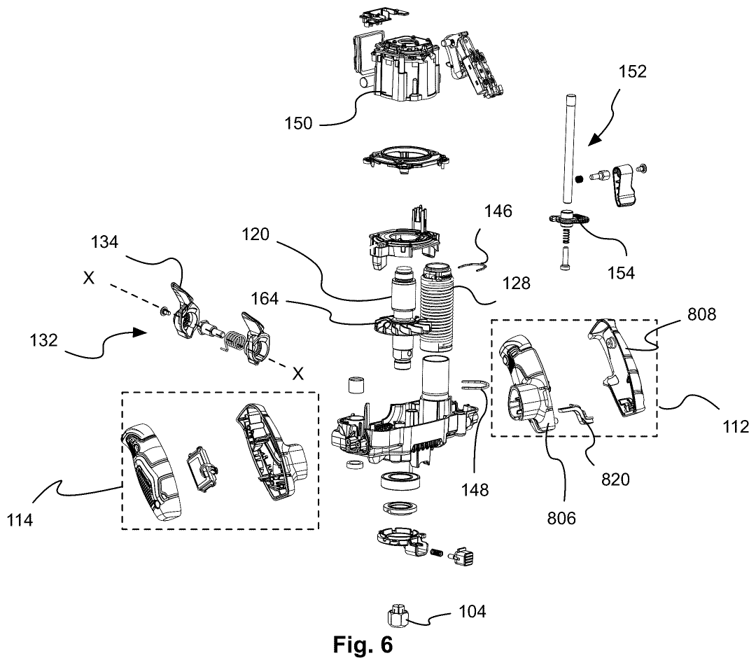

A motor 120 (best shown in FIG. 2) is mounted in the housing 102 for driving a collet 104. The motor 120 is optionally mounted within a motor housing 150 (best shown in FIG. 6). The motor housing 150 may be mounted to the housing 102. The motor 120 may be any suitable type of electric motor, such as a brushed or brushless DC motor, an AC motor, a stepper motor, or other types of motors known in the art. Optionally, the motor housing 150 is mounted to the housing 102 via dampeners e.g. rubber mounts (not shown) to reduce the vibration transmitted from the motor 120 to the housing 102 and, in turn, to the user.

The motor 120 is operatively connected to the collet 104 through a drive shaft 156, which transmits the rotational movement of the motor 120 directly to the tool holder e.g., the collet 104. The drive shaft 156 may comprise one or more bearings to decrease friction and ensure smooth rotation of the collet 104.

The motor 120 may comprise various cooling components, such as fans or cooling fins, to dissipate heat generated during operation. One such fan 164 is shown in FIG. 6. These cooling components may be encased within the motor housing 150 or the housing 102 of the power tool 100 and may be integrated into the design of the motor 120 itself.

A cutting tool bit (not shown) can be mounted in the collet 104 for engaging a workpiece (not shown). Typically, the cutting tool is a cutting tool bit for a power tool 100. In some examples the cutting tool bit is a router bit such as an upcut spiral router bit, a downcut spiral router bit, a straight router bit, a cove router bit, a chamfer router bit, a rabbeting router bit, a roundover router bit, a beading router bit, an ogee router bit or a panel raising router bit. Any other suitable router cutting tool bit can be mounted in the collet 104.

The collet 104 may be a cylindrical component that contains an inner bore to accommodate and grip the shank of the cutting tool bit. The collet 104 is known and will not be discussed in any further detail.

As shown in FIG. 1, the power tool 100 comprises a base portion 106 for engaging the workpiece. The base portion 106 comprises a base aperture 126 through which the cutting tool bit can project e.g., when the user plunges the housing 102 towards the base portion 106 and then the cutting tool bit projects through the base aperture 126. The base portion 106 is mounted to the housing 102 via first and second guide posts 108, 110. The first and second guide posts 108, 110 are slidably mounted to the housing 102 for adjusting the relative distance of the base portion 106 from the collet 104. In some examples, the first and second guide posts 108, 110 are removable. This means that the power tool 100 can be used without the base portion 106 engaging the workpiece.

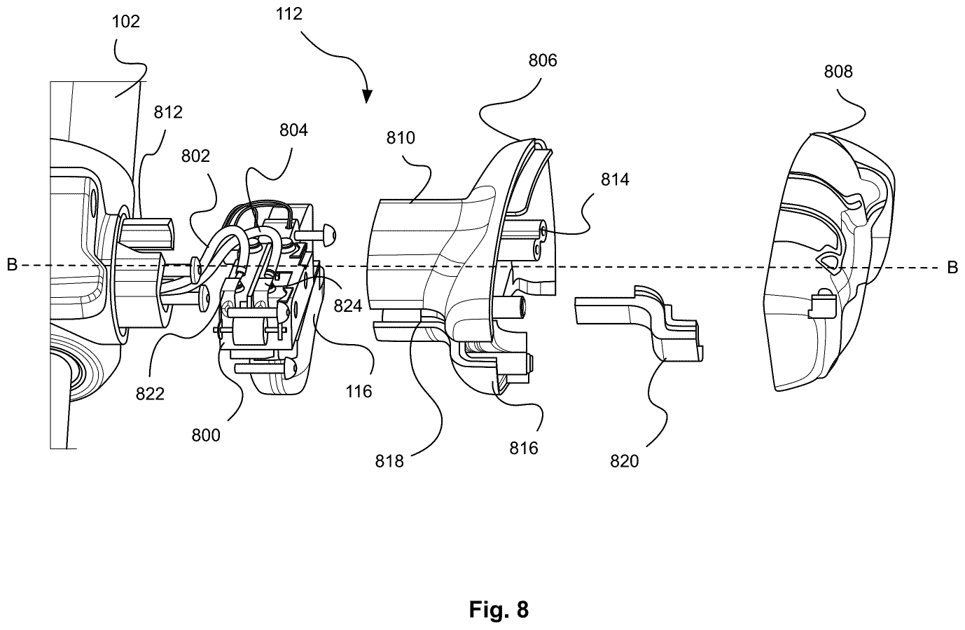

The housing 102 comprises a first handle 112 and a second handle 114 for the user to grip during operation. The first handle 112 and the second handle 114 have a different arrangement. The first handle 112 comprises a component 800 of the power tool 100. The component 800 is best shown in FIG. 8. In some examples, the component 800 comprises at least one electrical connection 802 electrically connected with the power source 122 e.g., the battery 122. In some examples, the component 800 is an electrical component. Alternatively, and some other examples the component 800 is an electronic component 800.

Since the component 800 is electrically connected to the power tool 100, one or more electrical connections e.g., first and second electrical wires 802, 804 need to extend from the first handle 112 to the housing 102.

In some examples, the first and second electrical wires 802, 804 are respectively connected to the main trigger switch 116 via first and second electrical tabs 822, 824 as shown in FIG. 8. The first and second folded electrical tabs 822, 824. The first and second folded electrical tabs 822, 824 are bent through approx. 180 degrees. This allows the main trigger switch 116 to be accommodated into the space inside of the first handle 112.

In some examples, the electrical or electronic component 800 is a main trigger switch 116 for operating the power tool 100. In some examples, the first handle 112 also comprises a lock button 118 for selectively locking the main trigger switch 116 into an “ON” status. This means that the user does not have to constantly keep pressure maintained on the main trigger switch 116 during operation of the power tool 100. In some examples, the main trigger switch 116 can be replaced with a momentary switch (not shown).

However, in some alternative examples, the electrical or electronic component 800 can be any other suitable device electrically connected to the power tool 100. Example, the electrical or electronic component 800 can be any type of sensor, an LED, a buzzer, or any other device. Furthermore, whilst the figures show that the first handle 112 comprises the component 800, the second handle 114 can also have the same construction of the first handle 112 as described herein. Indeed, the component 800 mounted in the first handle 112 can be the main trigger switch 116 and the component 800 mounted in the second handle 114 can be e.g., an LED.

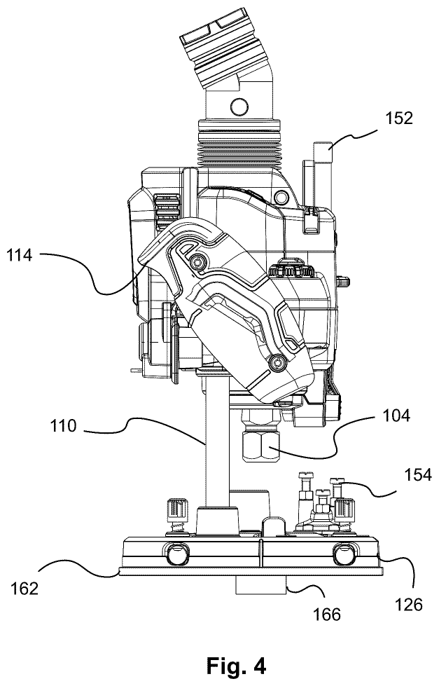

The user can hold both the first handle 112 and the second handle 114 to grip the power tool 100 during operation thereof. The first handle 112 and the second handle 114 optionally comprise a clam shell arrangement as shown in FIG. 6. As shown in FIGS. 3 and 4, the first handle 112 and the second handle 114 comprise a “T-shaped” profile. This means that the first handle 112 and the second handle 114 have an ergonomic profile and are comfortable when the user wraps their fingers and thumbs around the first and second handles 112, 114.

Indeed, the first handle 112 and the second handle 114 are separate handle elements that are mountable to the housing 102. Separate parts of the first handle 112 and the second handle 114 are shown in FIG. 6. Accordingly, the separate parts of the first handle 112 on the second handle 114 can be assembled before the first and second handles 112, 1140 mounted on the housing 102.

In some examples, the first and second handles 112, 114 are mounted to the housing 102 with one or more screw fastenings. In some other examples, any other type of fastening arrangement can be used, e.g., adhesive, clips, or clamps or a friction fit etc.

The motor 120 is electrically connected to an electric power source 122. In some examples, the electric power source 122 is a mains electrical supply. In some other examples, the electrical power source 122 is a battery 122. The battery 122 can be removably mountable to the housing 102 or integral to the housing 102. In some examples, the power tool 100 can be powered either from both a battery 122 and/or a mains electrical supply. The motor 120 is connected to a controller 130 (best shown in FIG. 2) mounted on a PCB in the housing 102. The controller 130 is configured to issue control instructions to the motor 120 in dependence of the user actuating the main trigger switch 116.

The battery 122 as shown in FIG. 1 is securely mounted to a top portion 124 of the housing 102. The battery 122 is configured to power the motor 120 and other electronic components. The battery 122 may comprise lithium-ion cells, nickel-metal hydride cells, or any other type of rechargeable or non-rechargeable power source.

The power tool 100 as shown in FIG. 1 is optionally a plunge router 100. However, in some examples, the power tool 100 is not a plunge router 100. Accordingly, the power tool 100 can be selectively operated in different modes. In a first mode, the power tool 100 is in a locked position. In the locked position, the first and second guide posts 108, 110 are fixed with respect to the housing 102. This means that the housing 102 and the collet 104 are fixed with respect to the base portion 106. Accordingly, the cutting tool (not shown) can be maintained at a set height above the workpiece. This means that the user of the power tool 100 can select how far the cutting tool projects through the aperture in the base portion 106.

In a second mode, the power tool 100 is in an unlocked position. In the unlocked position the first and second guide posts 108, 110 are slidable with respect to the housing 102. This means that the user can push down on the first and second handles 112, 114 and the first and second guide posts 108, 110 slide into or through the housing 102. In this way, the distance between the base portion 106 and the housing 102 can be adjusted. This means that the user can position the power tool 100 above the workpiece and then push the housing 102 towards the workpiece and the cutting tool plunges into the workpiece.

As discussed hereinafter, the power tool 100 is configured to be set in a plurality of unlocked positions for different operation modes of the power tool 100.

The user can select between the locked and unlocked position of the power tool 100 by using a locking system 132 (best shown in FIG. 6) mounted on the power tool 100. In some examples, the locking system 132 is actuatable with a locking lever 134.

FIG. 1 shows the locking lever 134 in a locked position. In some examples, the locking lever 134 is in the locked position in a vertical orientation. The locking lever 134 is mechanically coupled to the first and/or second guide posts 108, 110 such that relative movement of the first and second guide posts 108, 110 is prevented when the locking lever 134 is in the locked position.

In some examples, the locking lever 134 actuates a locking bolt (not shown) to engage the first guide post 108 or the second guide post 110. In this way, the locking bolt exerts a frictional force against the first or second guide posts 108, 110 when the locking lever 134 is in the locked position. Alternatively, the locking bolt can engage a detent or a hole in the first guide post 108 or the second guide post 110.

Accordingly, when the locking lever 134 is in the locked position the locking bolt clamps against or engages the first or second guide posts 108, 110 preventing relative movement therebetween. In some examples the locking lever 134 optionally engages a reciprocal hole or detent (not shown) in the second guide post 110 and the housing 102. In other examples, an additional second locking bolt (not shown) is used to also engage with the first guide post 108 such that both the first and the second guide posts 108, 110 are locked at the same time. In other examples, other mechanisms can be used to lock the first and second guide posts 108, 110 such as a latch-catch mechanism, a ball bearing engaging a detent in the first and second guide posts 108, 110 or any other suitable mechanism.

The locking lever 134 is moveable between the locked position shown in FIG. 1 and an unlocked position (not shown). In some examples, the locking lever 134 is rotatable between the locked position and the unlocked position about a rotational axis X-X of the locking lever 134 (as shown in FIG. 6). In some other examples, the locking lever 134 is slidable between the locked position and the first and second unlocked positions. Mechanical linkages (not shown) may be coupled between the locking lever 134 and the locking bolt for actuating engagement between the locking bolt and the first and second guide posts 108, 110.

When the user plunges the housing 102 towards the base portion 106, the collet 104 and the cutting tool project through the base aperture 126. A housing return spring 128 is optionally shown in FIG. 2 as is fixed with respect to the first guide post 108 at a first spring end 140 and connected to the housing 102 at a second spring end 142. In some examples the housing return spring 128 is fixed with respect to the first guide post 108 at a first spring end 140 with a first C-clip 146 and fixed with respect to the housing 102 at a second spring end 142 with a second C-clip 148. Other types of fasteners can be used instead of the first and second c-clips 146, 148. Accordingly, when the housing 102 is moved towards, the base portion 106, the housing return spring 128 extends and exerts a return force on the housing 102 to return the unplunged position (e.g., the power tool 100 as shown in FIG. 1). The housing return spring 128 is shrouded with a bellows 144 to prevent ingress of dirt, debris, or moisture into the housing return spring 128 or other parts of the power tool 100.

In order to adjust the depth of the plunge e.g., how far the collet 104 projects through the base aperture 126, the housing 102 comprises a depth rod 152. The depth rod 152 is configured to engage one or more depth screws 154 of a plunge depth stop mounted on the base portion 106. When the housing 102 is plunged towards the base portion 106, the housing 102 is prevented from moving further towards the base portion 106 when the depth rod 152 engages the depth screws 154 of the plunge depth stop. The amount the depth rod 152 extends towards the base portion 106 is adjustable by the user. Furthermore, the amount the depth screws 154 project towards the housing 102 from the base portion 106 are also adjustable by the user. For the purposes of clarity only one of the depth screws 154 are labelled. The plunge depth stop, the depth screws 154 and the depth rod 152 are known and will not be described in any further detail.

Turning back to FIG. 1, the power tool 100 comprises a dust extraction conduit 136. The dust extraction conduit 136 is connectable to a vacuum source such as a workshop vacuum. The first guide post 108 is hollow and comprises a first guide post conduit 138 which is in fluid communication with the dust extraction conduit 136 at a first end of the first guide post 108. The second end of the first guide post 108 is in fluid communication with the base portion 106 and the cutting tool. In this way, the first guide post conduit 138 couples the vacuum source via the dust extraction conduit 136 to the base portion 106. This means cutting chips and other debris from the workpiece can be collected and extracted during operation. A chip collector accessory 300 is optionally removably mountable to the base portion 106 or the sub-base adapter 162. The chip collector accessory 300 is mountable to the base portion 106 around the base aperture 126 when mounted directly to the base portion 106. Alternatively, chip collector accessory 300 is mountable to the sub-base adapter 162 around the sub-base adapter hole (not shown).

The base portion 106 provides a stable and flat surface in a plane parallel with axis A-A (as shown in FIG. 2). The base portion 106 is arranged to be positioned and secured against the workpiece during operation of the power tool 100. The base portion 106 may comprise a first base side 158 facing away from the workpiece, and a second base side 160 facing towards the workpiece. The base portion 106 may be formed from any suitable material such as metal, plastic, composite, or any combination thereof. The dimensions and geometrical features of the base portion 106 may be configured to ensure proper compatibility with a variety of accessories, as discussed below.

The base portion 106 may optionally comprise a plurality of mounting features, such as holes, slots, or recesses, which enable the secure attachment of other components such as a sub-base adapter 162. These mounting features may be arranged in a predetermined pattern or layout, which corresponds to complementary features on the sub-base adapter 162 for proper alignment and mounting.

The base portion 106 of the power tool 100 may be integrally formed with the housing 102 or may be a separate component that is securely attached or connected to the main body of the housing 102 as shown in the accompanying Figures. FIG. 12 shows the first guide post 108 and the second guide post 110 fixed with respect to the base portion 106.

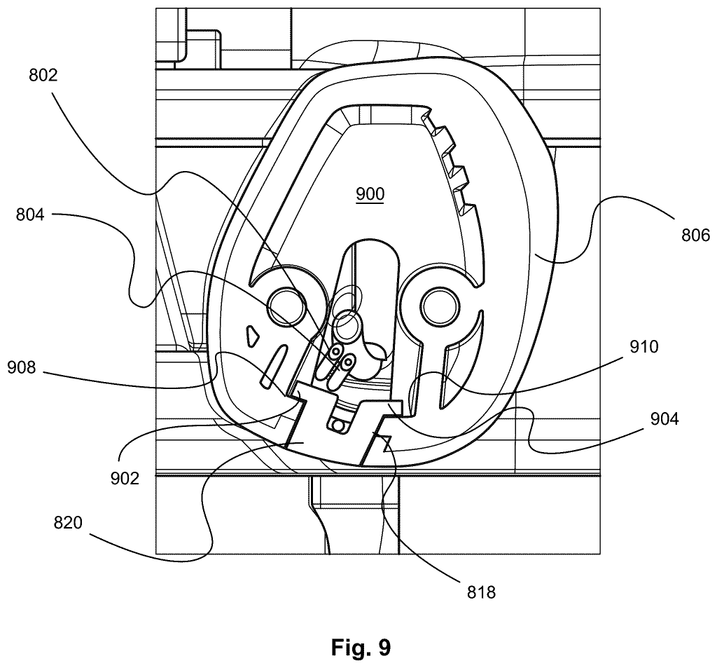

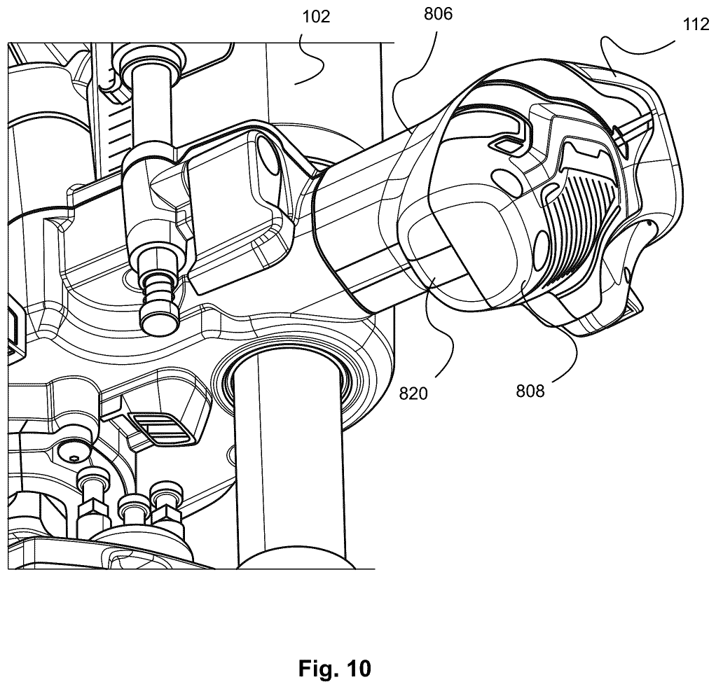

Turning to FIGS. 8, 9 and 10 the construction and structure of the first handle 112 will now be described in more detail. FIG. 8 shows an exploded perspective view of the first handle 112. FIG. 9 shows a cross-sectional side view of the first handle 112. FIG. 10 shows a perspective view of the first handle 112 assembled and mounted on the housing 102.

As shown in FIG. 8, the first handle 112 comprises a plurality of parts which are assembled together to form the first handle 112. In some examples, the first handle 112 comprises a handle body portion 806 and a cap portion 808. The cap portion 808 is mountable on the handle body portion 806 and fastened thereon with one or more screw fasteners.

The first handle 112 defines an internal cavity 900 as shown in FIG. 9. The internal cavity 900 is configured to receive the component 800 as mentioned above. As shown in FIG. 8, the component 800 is the main trigger switch 116 for actuating the power tool 100.

The handle body portion 806 comprises a projecting stem sleeve 810 which is configured to engage a reciprocal housing projection 812. The reciprocal housing projection 812 is configured to protrude into the projecting stem sleeve 810 of the handle body portion 806. The projecting stem sleeve 810 slides over the reciprocal housing projection 812 and is fastened thereto. The projecting stem sleeve 810 and the reciprocal housing projection 812 are secured together with one or more screw fasteners. In other examples the projecting stem sleeve 810 and the reciprocal housing projection 812 can be fastened together in different ways e.g., adhesive, clips, or clamps or a friction fit etc.

The handle body portion 806 and the cap portion 808 are configured to define the internal cavity 900 and surround the main trigger switch 116 when fastened together. The handle body portion 806 comprises a cup portion 816 connected to the projecting stem sleeve 810. The cup portion 816 is configured to receive the component 800 e.g., the main trigger switch 116. The cup portion 816 of the handle body portion 806 is generally curved and similar in shape to the cap portion 808.

The internal cavity 900 extends through the middle of the housing body portion 806 and within the projecting stem sleeve 810. This means that the first electrical wire 802 and the second electrical wire 804 can be threaded through the projecting stem sleeve 810.

As shown in FIG. 8, the handle body portion 806 and the cap portion 808 generally define a cylindrical, tubular, or barrel shaped volume when fastened together. The shape of the handle body portion 806 and the cap portion 808 can be modified to define any suitable internal volume for receiving one or more components 800 in the internal cavity 900. One or more features can be provided in the handle body portion 806 and the cap portion 808 for aligning or retaining the main trigger switch 116 before, during and after assembly of the first handle 112. In some examples, the handle body portion 806 comprises a projecting peg which is configured to engage the main trigger switch 116. This holds the main trigger switch 116 and the handle body portion 806 together during assembly.

The cap portion 808 is configured to mount on the housing body portion 806 and seal an end of the housing body portion 806. The main trigger switch 116 as shown in FIG. 8 is outside the handle body portion 806 and the cap portion 808. Accordingly, the arrangement as shown in FIG. 8 is during assembly of the first handle 112 to the housing 102.

As can be seen from FIG. 8, the main trigger switch 116 is electrically connected to the power source 122 and the electrical circuit (not shown) of the power tool 100. The main trigger switch 116 is connected to the electrical circuit via the first electrical wire 802 and the second electrical wire 804.

The main trigger switch 116 is then placed within the cup portion 816 of the handle body portion 806. In order to make assembly of the first handle 112 during manufacture easier, the first handle 112 comprises a unique arrangement for allowing placement of the first electrical wire 802 and the second electrical wire 804.

The handle body portion 806 comprises a handle slot 818 configured to receive the first electrical wire 802 and the second electrical wire 804 when the main trigger switch 116 is mounted in the first handle 112 and the main trigger switch 116 is electrically connected to the electrical circuit of the power tool 100. This means that the first electrical wire 802 and the second electrical wire 804 can be electrically connected to the electrical circuit before mounting in the first handle 112. This avoids the need to connect or solder the first electrical wire 802 and the second electrical wire 804 within the confined volume of the first handle 112. Instead, the first electrical wire 802 and the second electrical wire 804 can be connected to the electrical circuit and the main trigger switch 116 remote from the first handle 112.

The first electrical wire 802 and the second electrical wire 804 can then be fed manually into handle slot 818. The handle slot 818 is in communication with the internal cavity 900. Therefore, when the user feeds the first electrical wire 802 and the second electrical wire 804 into the handle slot 818, the first electrical wire 802 and the second electrical wire 804 are placed within the internal cavity 900 together with the main trigger switch 116.

The handle slot 818 extends along the entire of one side of the handle body portion 806. As can be seen from FIG. 8, the handle slot 818 extends along the underside of the first handle 112. The handle slot 818 extends at least in part in a direction parallel with a first handle axis B-B. The first handle axis B-B is the direction that the first handle 112 projects from the housing 102 when mounted to the housing 102.

In some examples, the handle slot 818 follows the periphery of the housing body portion 806. Since in some examples the first handle 112 comprises a T-shape, the handle slot 818 can extend in a direction which is not parallel to the first handle axis B-B.

In order to fill the handle slot 818 once the first electrical wire 802 and the second electrical wire 804 have been inserted into the handle slot 818, a handle slot insert 820 is configured to fill the handle slot 818. The handle slot insert 820 is configured to slidably engage with the handle slot 818. In some examples, the handle slot insert 820 is configured to slide into engagement with the handle slot 818 in a direction parallel with the first handle axis B-B.

In order to prevent the handle slot insert 820 from sliding out of the handle slot 818, the cap portion 808 is fastened to the handle body portion 806. The cap portion 808 then traps the handle slot insert 820 in the handle slot 818. In addition, the handle slot insert 820 can be fixed in place with adhesive, clips, or detents or any other mechanism. However, since the cap portion 808 overlays the handle slot 818 when the first handle 112 is assembled, additional fastening options for the handle slot insert 820 may not be necessary.

The handle slot insert 820 is also prevented from moving with respect to the handle slot 818 in a direction perpendicular to the first handle axis B-B. In some examples, the handle slot insert 820 comprises a first and second projecting lip 902, 904 which are configured to engage reciprocal first and second internal shoulder portions 908, 910 in the internal cavity 900. In this way, the first and second projecting lip 902, 904 engage the first and second internal shoulder portions 908, 910 and prevent the handle slot insert 820 from being removed.

As shown in FIG. 10, when the first handle 112 is assembled the first handle 112 is sealed. When the handle slot insert 820 fills the handle slot 818, the handle slot insert 820 seals the handle slot 818. Similarly, when the cap portion 808 engages the handle body portion 806, the cap portion 808 seals the handle body portion 806. This means that the internal cavity 900 in the first handle 112 and the component 800, e.g., the main trigger switch 116 mounted in the internal cavity 900 remain free from dirt.

In some other examples, there is no handle slot insert 820. Instead, the handle slot 818 is filled with silicone, or rubber. For example, the first handle 112 is overmolded when assembled and the handle slot 818 is then filled during the overmolding process. In some other examples, which may be less preferred, the handle slot 818 remains unfilled and no handle insert 820 or otherwise is used.

During manufacturing of the power tool 100, the following steps are taken when assembling the first handle 112 and the power tool 100.

In a first step the motor 120 is mounted in the housing 102. In a second step, the at least one component 800 is electrically connected with the power source 122 with at least one electrical connection 802, 804. For example, the second step can comprise soldering the first and second electrical wires 802, 804 to PCB connected to the electrical circuit of the power tool 100. Alternatively, the first and second electrical wires 802, 804 can comprise sliding contacts for engagement with reciprocal clip. In a third step, the at least one component 800 is inserted into the internal cavity 900 of at least one handle 112. In a fourth step, the at least one handle 112 is mounted to the housing 102. Finally in a fifth step, the at least one electrical connection 802, 804 is passed through the handle slot 818 after mounting the at least one handle 112 to the housing 102.

In an optional step, before the first handle 112 is mounted to the housing 102, the handle slot insert 820 is inserted into the handle slot 818 and the cap portion 808 is mounted on the housing body portion 806.

In another example, two or more examples are combined. Features of one example can be combined with features of other examples.

Examples of the present disclosure have been discussed with particular reference to the examples illustrated. However, it will be appreciated that variations and modifications may be made to the examples described within the scope of the disclosure.

We claim:

1. A power tool comprising:
a housing;
at least one handle mountable to the housing;
a motor mounted in the housing and electrically connected to a power source;
at least one component comprises at least one electrical connection electrically connected with the power source;
wherein the at least one handle comprises an internal cavity and the at least one component is mountable within the internal cavity; and
wherein the at least one handle comprises a handle slot configured to receive the at least one electrical connection when the at least one component is mounted within the at least one handle.

2. The power tool according to claim 1, wherein the handle slot is configured to receive the at least one electrical connection when the at least one handle is mounted to the housing.

3. The power tool according to claim 1, wherein a handle slot insert is configured to engage the handle slot and fill the slot.

4. The power tool according to claim 3, wherein the handle slot insert comprises at least one projecting lip configured to engage an internal shoulder portion of the at least one handle.

5. The power tool according to claim 1, wherein the handle slot extends at least partially around a periphery of the at least one handle.

6. The power tool according to claim 3, wherein a portion of the handle slot extends in a direction parallel with the at least one handle axis.

7. The power tool according to claim 6, wherein the handle slot insert is configured to slide into engagement with the handle slot in a direction parallel with the at least one handle axis.

8. The power tool according to claim 3, wherein the at least one handle comprises a handle body portion mountable to the housing and a cap portion mountable on the handle body portion.

9. The power tool according to claim 8, wherein the cap portion is configured to be mounted to the handle body portion and prevent the handle slot insert sliding out of the handle slot.

10. The power tool according to claim 8, wherein the handle slot extends along the entire side of the handle body portion.

11. The power tool according to claim 8, wherein the cap portion seals an end of the housing body portion when mounted to the housing body portion.

12. The power tool according to claim 3, wherein the handle slot insert seals the handle slot when in engagement with the handle slot.

13. The power tool according to claim 1, wherein the at least one electrical connection is a plurality of wires.

14. The power tool according to claim 1, wherein the at least one component is a trigger switch.

15. The power tool according to claim 1, wherein the at least one handle comprises a “T” shape.

16. The power tool according to claim 1, wherein the power tool is a router.

17. The power tool according to claim 1, wherein the at least one electrical connection is connected via at least one folded electrical tab (822, 824).

18. A handle mountable on a housing of a power tool having a motor mounted in the housing and electrically connected to a power source, the handle comprising:
an internal cavity configured to receive at least one component having at least one electrical connection electrically connected with the power source and mountable within the internal cavity; and
a handle slot configured to receive the at least one electrical connection when the at least one component is mounted within the handle.

19. A method of assembling a power tool comprising:
mounting a motor in a housing, the motor being electrically connected to a power source;
electrically connecting at least one component with the power source with at least one electrical connection;
inserting the at least one component in an internal cavity of at least one handle and mounting the at least one handle to the housing wherein the at least one handle comprises a handle slot; and
passing the at least one electrical connection through the handle slot after mounting the at least one handle to the housing.
